(19) United States
(12) Patent Application Publication
(10) Pub. No.: US 2015/0152287 A1
(43) Pub. Date: Jun. 4, 2015

(54) WATER-BASED COATING COMPOSITIONS

(71) Applicant: AXALTA COATING SYSTEMS IP CO., LLC, Wilmington, DE (US)

(72) Inventors: Carmen Flosbach, Wuppertal (DE); Paul P. Bruylants, Hever (BE); Jean-Luc Wietor, Duesseldorf (DE)

(21) Appl. No.: 14/409,618

(22) PCT Filed: Jun. 26, 2013
(86) PCT No.: PCT/US2013/047746

§ 371 Date: Dec. 19, 2014

Related U.S. Application Data
(60) Provisional application No. 61/664,207, filed on Jun. 26, 2012.

(51) Int. Cl. C09D 175/16

(52) U.S. Cl. CPC C09D 175/16

(57) ABSTRACT

Water-based coating compositions comprise a water-dilutable polyurethane hybrid binder, obtained by polymerization of a polyurethane macromonomer, containing a lateral and/or terminal vinyl group, in the presence of an unsaturated monomer copolymerizable with the polyurethane macromonomer, optionally a curing agent, and a pigment. The polyurethane macromonomer is based on a polyhydroxyl compound. The polyhydroxyl compound comprises at least about 50% by weight of a polycarbonate polyol, which is liquid at 20° C., the % by weight based on the total amount of the polyhydroxyl compound.

### CROSS-REFERENCE TO RELATED APPLICATION

This application is a U.S. National-Stage entry under 35 U.S.C. §371 based on International Application No. PCT/US2013/047746, filed Jun. 26, 2013, which was published under PCT Article 21(2) and which claims priority to U.S. Provisional Application No. 61/664,207, filed Jun. 26, 2012, which are all hereby incorporated in their entirety by reference.

### TECHNICAL FIELD

The technical field relates to water-based coating compositions comprising hybrid polyurethane binders. The water-based coating compositions are in particular suitable as pigmented water-based base coat compositions in multilayer coating and specifically in coating and repair coating of vehicles.

### BACKGROUND

For environmental reasons, water-based coating compositions are increasingly being used in vehicle coating, both for original coating and for repair coating.

Due to their excellent properties it is common practice to use water-dilutable polyurethane resins in the form of aqueous dispersions as the main binder in aqueous coating compositions and especially also in water-based base coat compositions.

The properties of the water-based base coat compositions and the coatings obtained thereof are substantially determined by the specific chemical structure of the polyurethanes used.

EP 0 427 979, for example, describes aqueous coating compositions which contain a water-dispersible binder and aluminum pigments, wherein the binder comprises a water-dispersible polyurethane polyurea containing at least 200 milliequivalents, per 100 g of solids, of chemically incorporated carbonate groups and not more than, in total, 320 milliequivalents, per 100 g of solids, of chemically incorporated urethane groups and chemically incorporated urea groups. These water-dispersible polyurethane polyureas are used as binders or binder components for water-borne metallic base coat compositions.

EP 98 752 describes aqueous polyurethane dispersions prepared by first reacting a diol containing ionic groups, a polyol-polyether or polyol-polyester and a diisocyanate to form an NCO group containing polyurethane prepolymer. In a second step the prepolymer is reacted with a hydroxyalkyl (meth)acrylate. The so obtained lateral vinyl groups containing prepolymer is then polymerized by free radical polymerization.

EP 0 522 419 also describes polyurethane dispersions suitable for the production of coating compositions. The polyurethane dispersions are prepared by polymerization of polyurethane macromonomers containing carboxyl, phosphonic and/or sulphonic acid groups and lateral vinyl groups, optionally together with terminal vinyl groups.

The principal disadvantage of the above coating compositions is an inadequate water resistance.

Furthermore, EP 0 661 321 describes water-based physically drying coating compositions comprising a mixture of 45-95% by weight of polyurethanes obtained by polymerization of polyurethane macromonomers containing carboxyl, phosphonic and/or sulphonic acid groups and lateral vinyl groups in the presence of unsaturated monomers, and 5-55% by weight of polyurethane resins containing urea or carbonate groups obtained by preparing a polyurethane prepolymer with OH groups and subsequent chain extension with polyisocyanates.

However, the coatings produced when using aqueous coating compositions do not in all respects achieve the high quality levels of conventional organic solvent-based coatings. For example, in particular in case of water-based effect base coat compositions, the long-term stability of the water-based base coat compositions is not satisfactory. For example, a thickening of the water-based compositions can be observed during storage. This is not acceptable in all applications where a long-term stability of more than 12 months is required, for example in vehicle repair coating.

EP 1 736 490 describes hydrolysis-stable clear coat compositions to be used as soft feel paints which comprise hydroxyl-free polyurethanes and hydroxyl-containing polyurethanes, wherein the polyurethanes comprise polycarbonate polyols containing at least 25% by weight of 1,4-butanediol.

Furthermore, EP 1736490 describes water-based coating compositions comprising hydroxyl-free polyurethane/urea binders, hydroxyl group containing polyurethane/urea binders and a cross-linker, wherein the polyurethane/urea binders comprise polycarbonate polyols having a fraction of at least 25% by weight of 1,4-butanediol as a synthesis component. The water-based coating compositions are used in particular as soft feel paints on plastics or wood substrates.

Water-based base coat compositions and water-based basecoat tints based on polyurethane dispersions of prior art often show speck formation during storage. In particular at lower temperatures or below 0° C., for example, during storage or transportation, agglomeration of binder particles may occur. This on the other hand can lead to quality issues after application of the coating composition. On the other hand storage and transport at higher temperatures causes higher costs and logistic problems. Most of refinish body shops do not have heated storage areas.

In addition WO 2011/075718 discloses a pigmented water-based coating composition comprising water-dilutable polyurethane/polyurea binders which are based on polyhydroxyl compounds, said polyhydroxyl compounds comprising at least 50% by weight of at least one polycarbonate polyol, which is liquid at 20° C. The physical drying of the water-based coating composition as well as orientation of effect pigments such aluminum pigments still needs improvement. Polyurethane hybrid binders are not disclosed here.

Accordingly, it is desirable to provide pigmented water-based coating compositions or water-based tints, in particular water-based effect base coat compositions and tints to be used in vehicle coating (coating of vehicle bodies and vehicle body parts), in particular in vehicle repair coating, which compositions are long-term stable for, e.g., at least 12-24 months, which compositions do not thicken during storage, even not at lower temperatures and temperatures below 0° C., and application of which yield coatings with good optical quality and a good metallic effect. The coatings obtained should also fulfil the conventional requirements that are applied to a vehicle coating, in particular a vehicle repair coating, for example with regard to chemical and weathering resistance and resistance to mechanical influences. In addition, other objects, desirable features and characteristics will become apparent from the subsequent summary and detailed description, and the appended claims, taken in conjunction with the accompanying drawings and this background.

### SUMMARY

An exemplary embodiment relates to water-based coating compositions comprising:

a water-dilutable polyurethane hybrid binder, obtained by polymerization of a polyurethane macromonomer, containing a lateral and/or terminal vinyl group, in the presence of an unsaturated monomer copolymerizable with the polyurethane macromonomer;

optionally, a curing agent; and

a pigment,

wherein the polyurethane macromonomer is based on a polyhydroxyl compound, said polyhydroxyl compound comprising at least about 50% by weight of a polycarbonate polyol, which is liquid at 20° C., the % by weight based on the total amount of the polyhydroxyl compound.

Surprisingly it has been found that water-based base coat compositions based on the above-described polyurethane binders do not thicken during storage within 12-24 months and yield coatings that have consistently good optical appearance and exhibit a very good effect or metallic effect. Moreover the coating compositions are not sensitive to freezing and do not lead to speck formation during storage at temperatures below room temperature.

The physical drying of the water-based coating composition is very good as well as orientation of effect pigments such as aluminum pigments is well developed.

In comparison, coating compositions with polyurethanes of the prior art based on solid polycarbonate polyols have a tendency to thicken during storage, e.g. within 12-24 months or even after 4 to 6 months. Thickening during storage may lead to viscosities at least three times higher than the starting viscosity. In addition the coating compositions are sensitive at low temperatures, e.g. below 0° C.

Moreover they lead to speck formation during storage at temperatures slightly below room temperature.

### DETAILED DESCRIPTION

The following detailed description is merely exemplary in nature and is not intended to limit the water-based coating compositions or the application and uses thereof. Furthermore, there is no intention to be bound by any theory presented in the preceding background or the following detailed description.

The term polyurethane macromonomer as used here and hereinafter shall be taken to mean a polymeric intermediate product containing at least one unsaturated group and still capable of polymerization with itself and additional unsaturated monomers.

The short term polyurethane binder as used here and hereinafter shall be taken to mean water-dilutable polyurethane hybrid binder.

The short term liquid polycarbonate polyol as used here and hereinafter shall be taken to mean a polycarbonate polyol which is liquid at 20° C.

The term (meth)acrylic as used here and hereinafter should be taken to mean methacrylic and/or acrylic.

Unless stated otherwise, all molecular weights (both number and weight average molecular weight) referred to herein are determined by GPC (gel permeation chromatographie) using polystyrene as the standard and tetrahydrofurane as the liquid phase.

Melting temperatures have been determined by means of DSC (Differential Scanning calorimetry) according to DIN 53765-B-10 at a heating rate of 10 K/min,

Glass transition temperatures have been determined by means of DSC (Differential Scanning calorimetry) according to ISO 11357-2 at a heating rate of 10 K/min.

Water-based coating compositions are coating compositions, wherein water is used as solvent or thinner when preparing and/or applying the coating composition. Usually, water-based coating compositions contain about 30 to 90% by weight of water, based on the total amount of the coating composition and optionally, up to about 20% by weight, preferably, below about 15% by weight of organic solvents, based on the total amount of the coating composition.

First of all the polyurethane binder to be used in the water-based coating composition contemplated herein shall be described in more detail.

The polyurethane binder can comprise at least about 100 milliequivalents, preferably about 100 to 450 milliequivalents of carbonate groups (per 100 g polyurethane binder solids). More preferred the polyurethane binder comprises at least about 100 milliequivalents, preferably about 100-450 milliequivalents of carbonate groups (per 100 g polyurethane binder solids) and at least about 100 milliequivalents, preferably about 100 about 300 milliequivalents of urethane and urea groups (per 100 g polyurethane binder solids).

A polyurethane macromonomer is used to prepare the polyurethane binder. The polyurethane macromonomer has preferably a number average molecular weight Mn of about 500 to about 20,000 and a weight average molecular weight Mw of about 5000 to about 100,000, a hydroxyl number of 0 to about 150 mg KOH/g and an acid number of about 10 to about 50, preferably of about 15 to about 35 mg KOH/g.

In an exemplary embodiment, the polyurethane macromonomer is based on one or more polyhydroxyl compounds, the polyhydroxyl compound comprising at least about 50% by weight, preferably about 60 to about 100% by weight of a liquid polycarbonate polyol, the % by weight based on the total amount of the polyhydroxyl compound. The liquid polycarbonate polyols may have, for example, a melting point below about 10 to about 15° C. and accordingly show an endothermic peak in the DSC curve. Also, the liquid polycarbonate polyol may not show an endothermic peak in the DSC curve, for example, they may not show an endothermic peak in the DSC curve above about −30° C. The liquid polycarbonate polyols have a glass transition temperature of, for example, about 0° C. or below, preferably of about −50 to about 0° C. The liquid polycarbonate polyols have preferably a number average molecular weight Mn of about 300 to about 5000, more preferred of about 500 to 4000.

A detailed description of the polycarbonate polyol is given in the description of component b) below.

The polyurethane macromonomer to be used for preparing the polyurethane binder can be obtained according to methods known to a person skilled in the art. In an embodiment, the polyurethane macromonomer is obtained by reacting components comprising:

a) a polyisocyanate, having preferably a molecular weight of about 126 to about 500,

b) a polyhydroxyl compound, having preferably a number average molecular weight Mn of about 300 to about 5000, the polyhydroxyl compound comprising at least about 50% by weight of one or more polycarbonate polyols, which is liquid at 20° C., the % by weight based on the total amount of the polyhydroxyl compound,

c) a compound containing a functional group reactive towards isocyanate groups and a group chosen from ionic groups, groups capable of forming ions, and non-ionic hydrophilic groups, and

d) a compound containing a vinyl group and a hydroxyl group, preferably at least two hydroxyl groups.

Optionally, an additional component may be reacted, too, e.g., a multi-functional compound having hydroxyl and/or amino groups and preferably a molecular weight of about 32 to about 300.

Component a): Any desired organic polyisocyanates, preferably diisocyanates may be used, individually or in combination, as component a) for the production of the polyurethane macromonomer. The polyisocyanates may, for example, be of an aromatic, aliphatic and/or cycloaliphatic nature and have a molecular weight of preferably about 126 to about 500. These may also comprise diisocyanates containing ether or ester groups. Examples of suitable diisocyanates are trimethylene diisocyanate, tetramethylene diisocyanate, pentamethylene diisocyanate, hexamethylene diisocyanate, propylene diisocyanate, ethylene diisocyanate, 2,3-dimethylethylene diisocyanate, 1-methyltrimethylene diisocyanate, 1,3-cyclopentylene diisocyanate, 1,4-cyclohexylene diisocyanate, 1,2-cyclohexylene diisocyanate, 1,3-phenylene diisocyanate, 1,4-phenylene diisocyanate, 2,4-tolylene diisocyanate, 2,6-tolylene diisocyanate, 1-isocyanatomethyl-5-isocyanato-1,3,3-trimethylcyclohexane, bis(4-isocyanatophenyl)methane, 4,4-diisocyanatodiphenyl ether, 1,5-dibutylpentamethylene diisocyanate, 2,3-bis(8-isocyanatooctyl)-4-octyl-5-hexylcyclohexane, 3-isocyanatomethyl-1-methylcyclohexyl isocyanate and/or 2,6-diisocyanatomethyl caproate.

It is also possible to use sterically hindered isocyanates with 4 to 25, preferably 6 to 16 C atoms, which contain in alpha position relative to the NCO group one or two linear, branched or cyclic alkyl groups with 1 to 12, preferably 1 to 4 C atoms as a substituent on the parent structure. The parent structure may consist of an aromatic or alicyclic ring or of an aliphatic linear or branched C chain having 1 to 12 C atoms. Examples of these are isophorone diisocyanate, bis(4-isocyanatocyclohexyl)methane, 1,1,6,6-tetramethylhexamethylene diisocyanate, 1,5-dibutylpentamethylene diisocyanate, 3-isocyanatomethyl-1-methylcyclohexyl isocyanate, p- and m-tetramethylxylylene diisocyanate and/or the corresponding hydrogenated homologues.

Component b): Compounds usable as component b) are polyester polyols, polycarbonate polyols, polyether polyols, polylactone polyols and/or poly(meth)acrylate polyols or the corresponding diols. The polyols and diols may in each case be used individually or in combination with one another.

However, it is essential that component b) comprises at least about 50% by weight of a liquid polycarbonate polyol, preferably with a molecular weight Mn of about 300 to about 5000, more preferred of about 500 to about 4000. The liquid polycarbonate polyols are viscous liquids at room temperature. They have, for example, a viscosity of below about 50,000 mPas (at 50° C.), preferably a viscosity of about 500 to about 20,000 mPas (at 50° C.).

Generally the liquid polycarbonate polyols comprise esters of carbonic acid that are obtained by reacting carbonic acid derivatives, for example diphenyl carbonate, dialkylcarbonates, e.g. dimethylcarbonate, or phosgene, with polyols, preferably with diols. Suitable diols which may be considered to prepare the liquid polycarbonate polyols are, for example, 1,3-propanediol, 2-methyl-1,3-propanediol, 1,4-butanediol, 1,3-butanediol, 1,5-pentandiol, 1,6-hexanediol, 3,3,5-trimethyl pentanediol, neopentylglycol and 2-ethyl-1,3-hexandiol. The polycarbonate polyols are preferably linear.

According to a preferred embodiment suitable liquid polycarbonate polyols are those based on a combination of 1,3-propanediol and 1,5-pentandiol, on a combination of 1,3-propanediol and 1,4-butandiol, on a combination of 1,4-butandiol and 1,6-hexanediol or on a combination of 1,5-pentandiol and 1,6-hexanediol. More preferred suitable liquid polycarbonate polyols/diols are those based on a combination of 1,3-propanediol and 1,5-pentandiol, and 1,5-pentandiol and 1,6-hexanediol. The molar ratio of the two diols in each of the above combinations is preferably in the range of about 3:1 to about 1:3, more preferred about 2:1 to about 1:2 and is most preferred about 1:1. The molar ratio of 1,5-pentandiol: 1,6-hexanediol in the combination is preferably in the range of about 3:1 to about 1:3, more preferred about 2:1 to about 1:2 and is most preferred about 1:1; the molar ratio of 1,3-propanediol: 1,5-pentandiol may preferably be in the range of about 3:1 to about 1:3, more preferably about 2:1 to about 1:2 and is most preferably about 1:1. Other diols may also be present in the diol combination, for example, to an extent of about 5 to about 20% by weight, based on the total amount of the diol combination.

Preferred liquid polycarbonate polyols have a hydroxyl number of about 40 to about 150 mg KOH/g solids and a number average molecular weight Mn of about 1000 to about 2000. According to a particularly preferred embodiment the diol combination to be used for preparing the liquid polycarbonate polyols consists of 1,5-pentandiol and 1,6-hexanediol or 1,3-propanediol and 1,4-butanediol in molar ratios as defined above. The diol combination may also consist of 1,6-hexanediol and 1,4-butanediol in molar ratios as defined above. The liquid polycarbonate polyols may be used as single compounds or as a mixture of polycarbonate polyols.

Preferred liquid polycarbonate polyols are polycarbonate diols with about 5 to about 15 carbonate groups per molecule. The polycarbonate polyols preferably contain substantially no carboxyl groups. They may, for example, have acid values of about <3 mg KOH/g solids, preferably of about <1 mg KOH/g solids. It is, however, also possible for the polycarbonate polyols to contain carboxyl groups, in which case they may, for example, have acid values of about 5 to about 50 mg of KOH/g solids.

The liquid polycarbonate polyols and diols are produced in a conventional manner known to a person skilled in the art. For example, they may be synthesized by performing ester exchange between a dialkyl carbonate and a mixture of aliphatic hydroxyl compounds, e.g., a mixture comprising 1,5-pentanediol and 1,6-hexanediol as major components and, optionally, other aliphatic glycols as minor components, in the presence of a catalyst customarily employed for ester exchange reaction. Suitable liquid polycarbonate polyols based on 1,5-pentanediol and 1,6-hexandiol and their preparation are described, for example, in EP 302 712.

Suitable liquid polycarbonate polyols and diols are also commercially available, for example, under the trade name Duranol®, e.g. Duranol® T5652, Duranol® T5651, from Asahi Kasei Chemicals Corporation.

In addition to the liquid polycarbonate polyols further polyols may be used as component b), for example, polyester polyols may be used. Suitable polyester polyols are produced in a conventional manner known to the person skilled in the art, for example, by polycondensation from organic dicarboxylic acids or the anhydrides thereof and organic polyols. The acid component for the production of the polyester polyols preferably comprises low molecular weight dicarboxylic acids or the anhydrides thereof having 2 to 17, preferably fewer than 16, particularly preferably fewer than 14 carbon atoms per molecule. Suitable dicarboxylic acids are for example phthalic acid, isophthalic acid, alkylisophthalic acid, terephthalic acid, hexahydrophthalic acid, adipic acid, trimethyladipic acid, azelaic acid, sebacic acid, fumaric acid, maleic acid, glutaric acid, succinic acid, itaconic acid and 1,4-cyclohexanedicarboxylic acid. The corresponding anhydrides, where existent, may be used instead of the acids. In order to achieve branching, it is also possible to add proportions of more highly functional carboxylic acids, for example trifunctional carboxylic acids such as trimellitic acid, maleic acid and dimethylolpropionic acid.

Polyols usable for the production of the polyester polyols are preferably diols, for example glycols such as ethylene glycol, 1,2-propanediol, 1,2-, 1,3- and 1,4-butanediol, 2-ethylene-1,3-propanediol, 1,6-hexanediol, 1,2- and 1,4-cyclohexanediol, hydrogenated bisphenol A and neopentyl glycol.

The diols may optionally be modified by small quantities of more highly hydric alcohols (alcohols with hydroxyl functionality above two). Examples of those alcohols that may also be used are trimethylolpropane, pentaerythritol, glycerol and hexanetriol. A proportion of chain-terminating, monohydric alcohols may also be used, for example those having 1 to 18 C atoms per molecule, such as propanol, butanol, cyclohexanol, n-hexanol, benzyl alcohol, isodecanol, saturated and unsaturated fatty alcohols.

In addition to the liquid polycarbonate polyols, also polyether polyols and/or polylactone polyols may be used as component b). Polyether polyols which may be considered are, for example, polyether polyols of the following general formula:

H(O—(CHR₁)ₙ)ₘOH,

in which R₁ means hydrogen or a lower alkyl residue (for example C₁ to C₆ alkyl), optionally with various substituents, n is 2 to 6 and m is 10 to 50. The residues CHR₁ may be identical or different. Examples of polyether polyols are poly(oxytetramethylene) glycols, poly(oxyethylene) glycols and poly(oxypropylene) glycols or mixed block copolymers which contain different oxytetramethylene, oxyethylene and/or oxypropylene units.

The polylactone polyols comprise polyols, preferably diols, which are derived from lactones, preferably from caprolactones. These products are obtained, for example, by reacting an epsilon-caprolactone with a diol. The polylactone polyols are distinguished by repeat polyester moieties which are derived from the lactone. These repeat molecular moieties may, for example, be of the following general formula:

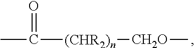

wherein n is preferably 4 to 6 and R₂ is hydrogen, an alkyl residue, a cycloalkyl residue or an alkoxy residue and the total number of carbon atoms in the substituents of the lactone ring does not exceed 12. Preferably used lactones are the epsilon-caprolactones, in which n has the value of 4. Unsubstituted epsilon-caprolactone is here particularly preferred. The lactones may be used individually or in combination. Diols suitable for reaction with the lactones are, for example, ethylene glycol, 1,3-propanediol, 1,4-butanediol and dimethylolcyclohexane.

In addition to component b), one or more low molecular weight polyhydric alcohols, preferably difunctional alcohols, with a molecular weight of below 500 g/mol may optionally also be used. Examples of such compounds are ethylene glycol, 1,2- and 1,3-propanediol, 1,3- and 1,4-butanediol, 1,6-hexanediol, 1,8-octanediol, 1,2- and 1,4-cyclohexanediol, dimethylolpropane, neopentyl glycol.

Preferably component b) consists of about 60 to 100% by weight of the above described liquid polycarbonate polyols and of 0 to about 40% by weight of other polyols. If other polyols are used in addition to the liquid polycarbonate polyols, polyester polyols, in particular polyester diols are preferred. More preferably component b) consists of 100% by weight of the above described liquid polycarbonate polyols or diols.

Component c): Component c) comprises low molecular weight compounds that have at least one, preferably more than one, particularly preferably two groups reactive with isocyanate groups and at least one ionic group, group capable of forming ions and/or non-ionic hydrophilic group. Groups capable of forming anions, which may be considered, are for example carboxyl, phosphoric acid and sulfonic acid groups. Preferred anionic groups are carboxyl groups. Groups capable of forming cations that may be considered are for example primary, secondary and tertiary amino groups or onium groups, such as quaternary ammonium, phosphonium and/or tertiary sulfonium groups. Preferred non-ionic hydrophilic groups are ethylene oxide groups. Anionic groups or groups capable of forming anions are preferred. Suitable isocyanate-reactive groups are in particular hydroxyl groups and primary and/or secondary amino groups.

Preferred compounds that may be considered as component c) are those containing carboxyl and hydroxyl groups. Examples of such compounds are hydroxyalkanecarboxylic acids of the following general formula:

(HO)ₓQ(COOH)_{y}

in which Q represents a linear or branched hydrocarbon residue with 1 to 12 C atoms and x and y each mean 1 to 3. Examples of such compounds are citric acid and tartaric acid. Carboxylic acids where x=2 and y=1 are preferred. A preferred group of dihydroxyalkanoic acids are alpha,alpha-dimethylolalkanoic acids. Alpha,alpha-dimethylolpropionic acid and alpha,alpha-dimethylolbutyric acid are most preferred.

Further examples of usable dihydroxyalkanoic acids are dihydroxypropionic acid, dimethylolacetic acid, dihydroxysuccinic acid or dihydroxybenzoic acid. Further compounds usable as component c) are acids containing amino groups, for example alpha,alpha-diaminovaleric acid, 3,4-diaminobenzoic acid, 2,4-diaminotoluenesulfonic acid and 4,4-diaminodiphenyl ether sulfonic acid. Further compounds usable as component c) are e.g. difunctional polyethylene oxide dialcohols.

Component d): Component d) is used to incorporate terminal and/or lateral vinyl groups into the polyurethane macromonomer.

The term “terminal vinyl groups” is intended to denote vinyl groups attached to the beginning or end of the polymer chain, while the term “lateral vinyl groups” is intended to denote vinyl groups not attached to the beginning or end of the polymer chain, but instead incorporated between the beginning and end.

Suitable compounds d) for incorporating lateral vinyl groups are monomers containing at least one vinyl group and at least two functional group capable of reacting with functional groups of the intermediate polyurethane prepolymer. Preferably compounds d) are monomers containing at least one vinyl group and at least two hydroxyl groups. Examples of those monomers are trimethylolpropane (TMP) derivatives such as, for example, TMP-monoallyl ether (2-propenyloxy-2-hydroxymethylpropanol), TMP-mono(meth)acrylate (2-(meth)acryloyloxy-2-hydroxmethylpropanol); glycerol mono(meth)acrylate; addition products of .alpha.,.beta.-unsaturated carboxylic acids, such as (meth)acrylic acid, onto diepoxides, for example bisphenol A diglycidyl ethers, hexanediol diglycidyl ethers; addition products of dicarboxylic acids, such as for example adipic acid, terephthalic acid or the like onto (meth)acrylic acid glycidyl esters; monovinyl ethers of polyols.

Compounds d) suitable for incorporating terminal vinyl groups are compounds having at least one vinyl group and one functional group capable of reacting with terminal functional groups of the polyurethane prepolymer, for example, compounds having at least one vinyl group and one hydroxyl group. Examples of those compounds are hydroxyl-functional (meth)acrylic acid esters. Hydroxy ethylmethacrylate is most preferred.

The polyurethane macromonomer can contain carboxyl, phosphonic and/or sulphonic acid groups. It may also contain hydroxyl-, thio-urethane and/or urea groups. Preferably the polyurethane macromonomer contains carboxyl- and hydroxyl groups.

Typically the polyurethane macromonomer is prepared in a solvent, e.g. organic solvents and/or unsaturated monomeric reactive diluents.

The polyurethane binder is prepared by polymerization of the polyurethane macromonomer with itself and with additional unsaturated monomers copolymerisable with the polyurethane macromonomer. These additional unsaturated monomers can also be acting as a solvent (reactive diluent) in the process of preparing the polyurethane macromonomer.

The polyurethane binders may be produced in various manners. One route comprises producing first a polyurethane macromonomer by polyaddition of the polyisocyanate a) with the polyhydroxyl compound b), and the compound c) containing a functional group reactive towards isocyanate groups and a group chosen from ionic groups, groups capable of forming ions and non-ionic hydrophilic groups and the compound d). The quantity ratios of the reactants, in particular of the polyisocyanate, may here be selected such that a macromonomer with terminal hydroxyl groups results. After conversion into the aqueous phase, this polyurethane macromonomer, which also contains vinyl groups (lateral and/or terminal vinyl groups) and preferably contains carboxyl or sulphonic acid groups, is polymerized via the vinyl groups with copolymerisable unsaturated monomers and free-radical initiators to yield the polyurethane binder, preferably in form of an aqueous dispersion, wherein in this case the polyurethane binder still bears hydroxyl groups.

A second embodiment is similar to the first embodiment, but unlike in the first embodiment the equivalent ratio of isocyanate groups to hydroxyl groups is selected such, that a polyurethane macromonomer with terminal isocyanate groups is obtained. The free isocyanate groups of this polyurethane macromonomer can then be reacted with primary or secondary amines or thioalcohols to yield urea or thiourethane groups. After conversion into the aqueous phase, this polyurethane macromonomer, which also contains vinyl groups (lateral and/or terminal vinyl groups) and preferably contains carboxyl or sulphonic acid groups, is polymerized via the vinyl groups with copolymerisable unsaturated monomers and free-radical initiators to yield the polyurethane binder, preferably in form of an aqueous dispersion.

In a third embodiment the monomer c), which bears the carboxyl, phosphonic acid and/or sulphonic acid group, is being incorporated into the previously formed polyurethane macromonomer. In this process variant, a polyaddition product is first formed from polyisocyanates a) polyhydroxy compound b), and monomers d), which contain both at least one vinyl group and at least two hydroxyl groups. Here too, a molar excess of polyisocyanate is used, such that the resultant macromonomer contains terminal isocyanate groups. In addition, this macromonomer then also contains lateral vinyl groups.

According to a fourth embodiment a polyurethane prepolymer free of isocyanate groups is prepared first by reacting components a), b) and c) in an appropriate ratio, e.g. in order to obtain an NCO value of about <0.3%. An NCO-functional polyurethane prepolymer is then obtained by reacting the previously obtained polyurethane prepolymer with a diol, additional components a) and components d), e.g. with an hydroxyl-functional (meth)acrylic monomer in appropriate amounts in order to achieve the desired NCO-functionality and to introduce unsaturated groups, such as (meth)acryloyl groups. The so-obtained NCO-functional polyurethane prepolymer is then reacted with a compound having one or more hydroxyl groups and one primary or secondary amino group, e.g., with diethanolamine or dimethanolamine, in order to introduce hydroxyl groups into the prepolymer.

Generally the polyurethane macromonomers may be produced using customary methods known in urethane chemistry. Catalysts may, for example, be used, such as for example tertiary amines, such as for example triethylamine, dimethylbenzylamine, diazabicyclooctane, together with dialkyltin(IV) compounds, such as for example dibutyltin dilaurate, dibutyltin dichloride, dimethyltin dilaurate. In particular, the reaction proceeds in the presence of an organic solvent or in the presence of a so-called reactive diluent. Organic solvents which may be considered are those which may subsequently be eliminated by distillation, for example methyl ethyl ketone, methyl isobutyl ketone, acetone, tetrahydrofuran, toluene, and xylene. These organic solvents may be entirely or partially removed by distillation after production of the polyurethane macromonomers or after free-radical polymerization. Instead of or in addition to these organic solvents, it is also possible to use water-dilutable high boiling solvents, for example N-methylpyrrolidone, which then remain in the dispersion. Reactive diluents which may be used are, for example, alpha, beta-unsaturated monomers as are copolymerized in the final state with the polyurethanes containing vinyl groups. Examples of such monomers, which may also be used as reactive diluents, are alpha, beta-unsaturated vinyl monomers such as alkyl acrylates, alkyl methacrylates and alkyl crotonates with 1 to 20 carbon atoms in the alkyl residue, di-, tri- and tetraacrylates, -methacrylates and -crotonates of glycols, tri- and tetrafunctional alcohols, substituted and unsubstituted acrylamides and methacrylamides, vinyl ethers, alpha, beta-unsaturated aldehydes and ketones, vinyl alkyl ketones with 1 to 20 carbon atoms in the alkyl residue, vinyl ethers, vinyl esters, diesters of alpha, beta-unsaturated dicarboxylic acids, styrene, styrene derivatives, such as for example alpha-methylstyrene.

In order to achieve sufficient water-reducibility of the polyurethane macromonomer the ionic groups or groups convertible into ionic groups of the polyurethane macromonomer are at least partially neutralized. The polyurethane macromonomer preferably contains anionic groups, for example carboxyl groups. The anionic groups are neutralized with bases. Examples of basic neutralizing agents are tertiary amines such as trimethylamine, triethylamine, dimethylethylamine, dimethylbutylamine, N-methylmorpholine, dimethylethanolamine and dimethylisopropanolamine. Alkali hydroxides such as LiOH, KOH and NaOH can also be used.

After neutralization, the NCO-functional polyurethane macromonomer is converted into the aqueous phase. Neutralization and conversion into the aqueous phase may, however, also proceed simultaneously. If non-ionic hydrophilic groups, e.g. ethylene oxide groups, are present, it is preferred that they are present in addition to ionic groups, preferably in addition to anionic groups. In addition thereto, it is possible to obtain water-dilutability via external emulsifiers.

In order to produce the final polyurethane binder, the polyurethane macromonomers are converted into the aqueous phase by adding water. Then the macromonomers are polymerized by free-radical initiated polymerization using methods which are known per se. Unless already present as so-called reactive diluents, unsaturated monomers are added during this polymerization operation and polymerized with the polyurethane macromonomer. Examples of unsaturated monomers are vinyl functional monomers like alkyl acrylates, alkyl methacrylates and alkyl crotonates with 1 to 20 carbon atoms in the alkyl rest, di-, tri- and tetracrylates, -methacrylates, and -crotonates, substituted and un-substituted acryl- and methacrylamides, vinylethers, alpha, beta-unsaturated aldehydes and ketones, vinylalkyl ketones with 1 to 20 carbon atoms in the alkyl rest, vinylethers, vinylesters and diesters of alpha, beta-unsaturated dicarboxylic acids, styrene, styrene derivatives, like, e.g., alpha-methylstyrene. Functionalized monomers like hydroxyl functional acrylates or methacrylates or unsaturated carboxylic acids such as acrylic acid and methacrylic acid can also be used.

The resultant polyurethane binders can have a number average molecular weight (Mn) of about 30000 to about 500000, preferably of about 50000 to about 250000. The proportion of unsaturated monomers to the proportion of polyurethane macromonomer is preferably about 10% by weight to about 50% by weight, more preferred about 10% by weight to about 35% by weight, based on the total amount of unsaturated monomers and polyurethane macromonomer.

The acid values of the polyurethane binder are in the range from about 5 to about 80 mg KOH/g, preferably about 10 to about 40 mg KOH/g. The polyurethane binders have preferably hydroxyl values of about 20 to about 100 mg KOH/g.

Such polyurethane binders and binder dispersions and the production thereof are described, for example, in DE-A-41 22 265.

In principle, all components a) to d) are reacted in a manner known to a person skilled in the art. Type and amount of each individual component are selected such that the above-stated characteristics of the resultant polyurethane macromonomer and the polyurethane binder, such as content of urethane and urea groups, carbonate groups, hydroxyl and acid value, are obtained.

The resulting polyurethane binder dispersion has a solids content of, for example about 25 to about 50% by weight, preferably of about 30 to about 45% by weight.

The polyurethane binder may optionally be used in combination with proportions of further water-dilutable resins. Further water-dilutable resins which may be considered are, for example, conventional water-dilutable(meth)acrylic copolymers, polyester resins and optionally modified polyurethane resins differing from the above-described water-dilutable hybrid polyurethane. Additional water-dilutable resins may be used in amounts of about 10 to about 20% by weight based on the resin solids of the hybrid polyurethane.

The coating composition contemplated herein may optionally comprise at least one curing agent B) which curing agent is capable of entering into a cross-linking reaction with reactive functional groups, e.g. hydroxyl groups, of the hybrid polyurethane and of additional binder components. The curing agents that can be used are not subject to any particular restrictions. All curing agents usually used to prepare aqueous coating compositions, e.g., in the field of automotive and industrial coating can be used. Those curing agents as well as preparation methods for the curing agents are known to the person skilled in the art and are disclosed in detail in various patents and other documents. Depending on the type of reactive functional groups of the hybrid polyurethane and the optionally present additional binders the following cross-linking agents may, for example, be used: polyisocyanates with free isocyanate groups or with at least partially blocked isocyanate groups, amine/formaldehyde condensation resins, for example, melamine resins. In a preferred embodiment hybrid polyurethanes and optionally present additional binders with hydroxyl groups and curing agents with free polyisocyanate groups are used.

The binder components and the curing agent are used in such proportion that the equivalent ratio of reactive functional groups of polyurethane macromonomer and additional binders to the corresponding reactive groups of the curing agent B) can be about 5:1 to about 1:5, for example, preferably, about 3:1 to about 1:3, and in particular, preferably, about 1.5:1 to about 1:1.5.

The water-based coating compositions contemplated herein contain a pigment C). Pigments C) may be any color and/or special effect imparting pigments that provide the final coating with a desired color and/or effect.

Suitable pigments are virtually any special effect-imparting pigments and/or color-imparting pigments selected from among white, colored and black pigments, in particular those typically used in pigmented base coat coating compositions in vehicle coating.

Examples of special effect pigments are conventional pigments which impart to a coating a special effect, e.g. a color flop and/or lightness flop dependent on the angle of observation, are metal pigments. Example of metal pigments are those made from aluminum, copper or other metals, interference pigments such as, for example, metal oxide coated metal pigments, for example, iron oxide coated aluminum, coated mica such as, for example, titanium dioxide coated mica, pigments which produce a graphite effect, iron oxide in flake form, liquid crystal pigments, coated aluminum oxide pigments, coated silicon dioxide pigments. Examples of white, colored and black pigments are the conventional inorganic or organic pigments known to the person skilled in the art, such as, for example, titanium dioxide, iron oxide pigments, carbon black, azo pigments, phthalocyanine pigments, quinacridone pigments, pyrrolopyrrole pigments, and perylene pigments. Preferably the coating compositions contemplated herein contain an effect-imparting pigment, optionally in combination with a color-imparting pigment.

In addition the coating compositions contemplated herein may contain conventional coating additives. Examples of conventional coating additives are levelling agents, rheological agents, such as highly disperse silica, polymeric urea compounds or layered silicates, thickeners, such as partially crosslinked polycarboxylic acid or polyurethanes, defoamers, wetting agents, anticratering agents, dispersants and catalysts. The additives are used in conventional amounts known to the person skilled in the art, for example, of about 0.1 to about 5 wt. %, relative to the solids content of the coating composition.

The water-based coating compositions may contain conventional organic coating solvents, for example, in a proportion of preferably less than about 20 wt. %, particularly preferably of less than about 15 wt. %. These are conventional coating solvents, which may originate, for example, from the production of the binders or are added separately. Examples of such solvents are alcohols like n-butanol, isobutanol, isopropylalcohol, glycolethers or glycolesters like butylglycol, butyldiglycol, esters like butylacetate, butylglycolacetate, ketones like acetone, methylethylketone, methylisobutylketon, aliphatic or aromatic solvents like xylene, and other organic solvents typically used in water-based coating compositions. However, hydroxyl functional organic solvents can be used only after having reacted all isocyanate groups.

Furthermore, the coating compositions contemplated herein contain water, preferably about 50 to about 80% by weight, especially preferred about 60 to about 75% by weight, relative to the entire coating composition.

The water-based coating compositions have solids contents of, for example, about 10 to about 45% by weight, preferably of about 15 to about 35% by weight. The ratio by weight of pigment content to the resin solids content is, for example, from about 0.05:1 to about 2:1. For special-effect water-based base coat coating compositions it is preferably about 0.06:1 to about 0.6:1; for solid color (single-tone) water-based base coat coating compositions it is preferably higher, for example, about 0.06:1 to about 2:1, in each case relative to the weight of solids.

In order to produce the water-based coating compositions, it is possible to use paste resins or dispersing agents for grinding or incorporating the pigments. The water-based coating compositions can also be formulated and used in form of concentrated or balanced pigmented tints.

In another exemplary embodiment, the use of the above described water-based coating compositions in multilayer coating of substrates is provided, in particular in multilayer coating or repair coating of vehicles, i.e. of vehicle bodies and vehicle body parts.

The coating compositions and the process contemplated herein may particularly advantageously be used in vehicle repair coating. In vehicle repair coating, pigmented coating compositions of a particular color and/or effect are generally prepared by mixing tints of different color to provide a coating with a desired color and/or effect. The coating compositions herein may thus also be used, for example, as a component of a “paint mixing system”, as is in particular used in vehicle repair coating for the production of color-imparting and/or special effect-imparting base coat coating compositions. As is known, such a paint mixing system is based on a defined number of individual standardized mixing components containing coloring and/or special effect pigments and optionally further components, for example binder components, which can be mixed according to a mix formula to yield a coating with the desired color/special effect.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1. A water-based coating composition comprising;
a water-dilutable polyurethane hybrid binder, obtained by polymerization of a polyurethane macromonomer, containing a lateral and/or terminal vinyl group, in the presence of an unsaturated monomer copolymerizable with the polyurethane macromonomer;
optionally a curing agent; and
a pigment,
wherein the polyurethane macromonomer is based on a polyhydroxyl compound, the polyhydroxyl compound comprising at least about 50% by weight of a polycarbonate polyol, which is liquid at 20° C., the % by weight based on the total amount of the polyhydroxyl compound.

2. The water-based coating composition of claim 1, wherein the polyurethane macromonomer is obtained by reacting components comprising:
a polyisocyanate;
a polyhydroxyl compound, the polyhydroxyl compound comprising at least about 50% by weight of a polycarbonate polyol, which is liquid at 20° C., the % by weight based on the total amount of the polyhydroxyl compound;
a compound containing a functional group reactive towards isocyanate groups and a group chosen from ionic groups, groups capable of forming ions and non-ionic hydrophilic groups; and
a compound containing a vinyl group and a hydroxyl group.

3. The water-based coating composition of claim 1, wherein the water-dilutable polyurethane hybrid binder comprises at least about 100 milliequivalents of carbonate groups (per 100 g polyurethane binder solids).

4. The water-based coating composition of claim 3, wherein the water-dilutable polyurethane hybrid binder comprises at least about 100 milliequivalents of carbonate groups (per 100 g polyurethane binder solids) and at least about 100 milliequivalents of urethane and urea groups (per 100 g polyurethane binder solids).

5. The water-based coating composition of claim 1, wherein the water-dilutable polyurethane hybrid binder has a hydroxyl value of 0 to about 150 mg KOH/g and an acid value of about 15 to about 50.

6. The water-based coating composition of claim 1, wherein the polyhydroxyl compound comprises about 60 to about 100% by weight of the polycarbonate polyol, which is liquid at 20° C., the % by weight relative to the total amount of polyhydroxyl compound.

7. The water-based coating composition of claim 1, wherein the at least one polycarbonate polyol, which is liquid at 20° C., has a number average molecular weight Mn of 300-5000.

8. The water-based coating composition of claim 1, wherein the polycarbonate polyol which is liquid at 20° C. is based on a combination of 1,3-propanediol and 1,5-pentandiol, on a combination of 1,3-propanediol and 1,4-butandiol, on a combination of 1,4-butandiol and 1,6-hexanediol and/or on a combination of 1,5-pentandiol and 1,6-hexanediol.

9. The water-based coating composition of claim 1, wherein the polycarbonate polyol which is liquid at 20° C. is based on a combination of 1,5-pentandiol and 1,6-hexanediol and/or a combination of 1,3-propranediol and 1,4-butanediol.

10. The water-based coating composition of claim 8, wherein the molar ratio of the two diols in each combination is in the range of about 3:1 to about 1:3.

11. The water-based coating composition of claim 1, wherein the pigment comprises an effect pigment.

12. (canceled)

13. (canceled)

14. The water-based coating composition of claim 9, wherein the molar ratio of the two diols in each combination is in the range of about 3:1 to about 1:3.
